(19) United States
(12) Patent Application Publication
(10) Pub. No.: US 2018/0011389 A1
(43) Pub. Date: Jan. 11, 2018

(54) Modular Instant and Digital Back for Film TLR Cameras

(71) Applicant: Petrica-Sandel Baciu, Tenafly, NJ (US)

(72) Inventor: Petrica-Sandel Baciu, Tenafly, NJ (US)

(21) Appl. No.: 15/207,449

(22) Filed: Jul. 11, 2016

(51) Int. Cl. G03B 17/48; G03B 17/02; G03B 17/56; H04N 5/225

(52) U.S. Cl. CPC G03B 17/48; H04N 5/2253; G03B 17/02; G03B 17/568; H04N 5/2252

(57) ABSTRACT

The invention is an improved device for converting a Twin Lens Reflex (TLR) film camera into Instant Film TLR or Digital Twin Lens Reflex (D-TLR) camera, by using a modular assembly which is the combination of a cartridge holder, an interchangeable instant film cartridge or a minicomputer with a digital sensor (CCD or CMOS) system, and a power bank, all interconnected at the back and bottom of the film camera.

This invention is an improved assembly of mechanical and electronic devices that can be attached to the film TLR camera body that can incorporate optional cartridges: for instant film or digital sensor. By using the lenses, electric input for flash and mechanism native to the film camera, the assembly can produce instant film when a film cartridge is used or can produce and store digital images when a digital cartridge is used. Digital images obtained using this assembly are dependent on the imagine sensor characteristics (size, type (CCD or CMOS), crop sensor ratio) and functions, but overall will provide a digital imagine that has similar optical characteristics as those obtained by traditional film exposure techniques.

### BACKGROUND OF THE INVENTION

Image sensors are currently largely used for digital cameras, being one of the largest market applications, but very rarely are used for the TLR cameras, especially for the film ones. Historically, the first digital cameras added, to a Single Lens Reflex (SLR) film camera body, a separate assembly attached on the back, which contained a digital sensor with electronics for processing the sensor input. Typical, only SLR film cameras have been used as a base for making Digital Single Reflex Cameras (D-SLR). Another segment market is for digital backs, commonly used for medium format cameras, and due to the sensor size and the technologies involved, those backs extremely expensive.

With the advancements in microelectronics, the size of crop sensors has decreased and so has the price. Nowadays, the technologies allows for the insertion of an image capturing system (hardware, sensor and power assemblies) inside an old camera without the need for physical alteration of the camera itself. That will convert an old film camera into an instant film camera or a digital camera, combining the characteristics and capabilities of the existing instant film, mirror less cameras, and digital backs. The current patent presents an improved way to perform these conversions. The relevant related technologies are shown in the following United States of America and Japan patents:

U.S. Pat. No. 4,903,063 A Yoshio Hara

U.S. Pat. No. 5,541,683 A Masanobu Kihara, Takeshi Tamura, Katsuyoshi Asakura, Hiroshi Ohmura, Hidefumi Obo, Ryuzi Uemura

U.S. Pat. No. 7,195,406 B2 Tetsuya Takatori, Mikio Okajima, Katsuyoshi Asakura, Tomoyuki Takahashi, Toshiharu Naito, Kenji Kobayashi,

U.S. Pat. No. 2,990,756 A Richard Weiss

U.S. Pat. No. 2,543,181 A Edwin H Land

U.S. Pat. No. 6,490,414 B2 Hidemi Sasaki, Teruaki Koizumi

U.S. Pat. No. 5,001,502 A Lawrence M. Douglas

U.S. Pat. No. 4,568,167 A Duncan C. Sorli

U.S. Pat. No. 5,608,477 A Mitsuru Shimizu, Ko Aosaki, Michio Cho

U.S. Pat. No. 6,304,725 B2 Kiichiro Kitagawa, Katsuyoshi Asakura

U.S. Pat. No. 6,183,144 B1 Kazunori Mizuno, Nobuo Sugiyama, Tetsuya Takatori, Tomoyuki Takahashi, Koichi Hatakeyama

US 20050263026 A1 Ko Aosaki, Hiroshi Omura, Hiroyuki Uchiyama, Yoshikuni Nishiura, Toshita Hara

U.S. Pat. No. 3,394,644 A Ettischer Helmut

JP 2012-242615 Nikon

JP 2010-283651 Nikon

JP 2014-146931 Sony

JP 2014-175729 Olympus

U.S. Pat. No. 6,365,950 B1 Il-Young Sohn

U.S. Pat. No. 4,977,584 A Akiyoshi Kohno, Atsushi Mikoshiba

U.S. Pat. No. 696,788 A Clile C Allen

U.S. Pat. No. 2,495,355 A Stahl Rodolphe

U.S. Pat. No. 2,644,381 A Mendelsohn Samuel

U.S. Pat. No. 2,766,658 A Gerhard Schwesinger

U.S. Pat. No. 2,967,471 A Sommermeyer Friedrich

U.S. Pat. No. 2,990,756 A Richard Weiss

U.S. Pat. No. 3,067,664 A George H Winslow

U.S. Pat. No. 3,143,052 A Prochnow Claus, Weiss Richard

U.S. Pat. No. 4,704,023 A Kenneth J. Curran

US 20070122146 A1 Jim Ryu

US 20080079830 A1 Gerald Lepage

US 20130308047 Chun-Ming Chen, Di Wu

U.S. Pat. No. 6,453,126 B1 Abe Tetsuya

U.S. Pat. No. 5,561,458 A David V. Cronin et al.

U.S. Pat. No. 6,351,282 B1 William DeLeeuw et al.

U.S. Pat. No. 4,348,086 A Martin Forscher

US 20080239122 A1 Nikolaos Georgis et al.

U.S. Pat. No. 6,035,144 A Karl Gfeller

US 20060197014 A1 Masafumi Inuiya

US 20170171449 A1 Kino Tatsuya

U.S. Pat. No. 6,035,147 A Yuichi Kurosawa

U.S. Pat. No. 7,676,151 B2 Takeshi Misawa et al.

U.S. Pat. No. 6,374,060 B1 Makoto Mogamiya

U.S. Pat. No. 6,181,883 B1 Abhay Oswal

U.S. Pat. No. 50,040,068 A Kenneth A. Parulski at al.

U.S. Pat. No. D510,745 S Masayuki Sakai

U.S. Pat. No. 5,282,040 A Itzhak Sapir

U.S. Pat. No. 6,943,820 B2 Dominik J. Schmidt

U.S. Pat. No. 6,278,481 B1 Dominik J. Schmidt

US 20050117899 A1 Evan George Selby

U.S. Pat. No. 6,337,955 B1 Tetsuji Shono

U.S. Pat. No. 6,370,339 B1 Jonathan M. Stern et al.

Though ideas of converting film cameras have achieved successes by using external assemblies that require physical modifications or alterations of the film camera, there has been a continuing need for improving and widening the field of applications for internal assemblies without modifying the initial design of the film camera itself. This invention provides a solution, producing a multifunctional film camera with instant film and digital capabilities.

### SUMMARY OF THE INVENTION

This invention is useful in the respect that it combines the old film camera's design with both instant film and new digital sensors and electronic assemblies that can be inserted inside or attached to a film TLR camera without performing modifications to the cameras body itself (excepting the replacement of original film back cover). By using the basic optical and electric signals of a vintage TLR film camera it obtains, at the user's decision, either an instant film picture, or a digital image with the same visual properties as one obtained by using the traditional film process. It will require the use of the film camera's flash triggering signal, a cable or wireless signal transmitted to a trigger that will release the instant film, or a signal for a digital sensor with corresponding hardware module, with a power bank supply. A cartridge type of receptor that can be swapped for use of standard mini instant film picture or a digital sensor captures the image signal. Depending on the cartridge type, the imagine can be produced by a chemical reaction of the instant film or digitally processed by the hardware module, and the image data saved onto a SD card or wirelessly transferred to an app that has several image processing and online data sharing capabilities. Similar to the idea of having interchangeable lenses, the current patent is exploring the idea of having fixed lenses on camera body with interchangeable backs as either instant film or digital sensors in swappable/interchangeable cartridges.

### DETAILED DESCRIPTION OF THE INVENTION

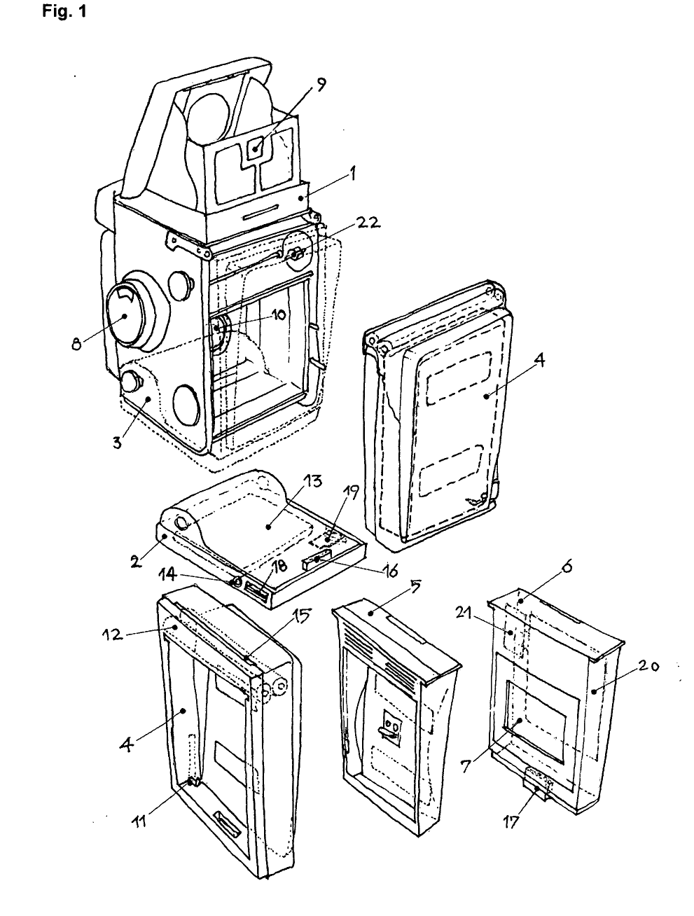

The design of the assembly of devices for a TLR film camera is detailed and the functions are explained. The way in which the above objective for the overall assembly is achieved is best explained with reference to FIG. 1.

In FIG. 1, a typical film TLR camera 1 inner part allows the space for an assembly of several devices: a power bank device enclosure 2 inside of the film housing 3, a cartridge holder assembly 4 with capability to swap an instant film cartridge 5 or a digital cartridge 6 that has been incorporated inside a camera sensor 7 data capturing process hardware 20. All are to be attached to the TLR film camera body, including the bottom and the back of the TLR, which is shown with the back cover removed to allow the installation of the cartridge holder 4 and the power bank 2. The resulting in-camera assembly provides either instant film photography or digital imagery; it's the users choice which is to be carried out. The digital imagine captured by the digital cartridge can be shared wirelessly to other devices or media sharing services.

The basic optic characteristics of the TLR camera are set-up by the photographer and with the help of an app the settings are synchronized with the sensor, maintaining the same settings. For example, if the film camera has the settings as a shutter speed of 1/125 sec and f=5.6, similar settings are inserted into the app. In addition, the digital ISO in the camera sensor settings matches the film sensitivity ASA.

The capturing of the image is done by using the film camera optical assembly 10 that is brought into focus by adjusting the focus knob 8 once the photographer observes the imagine from the taking lens through the viewer 9, this being one of the characteristics of the TLR photography process.

For transferring the film lenses optical signal to the image capturing devices assembly the same steps for taking a film photograph are followed by the photographer: define aperture, shutter speed and adjust the focus; the instant film or the sensor is set-up to capture the optical input. Specifically for the instant film, the manufacturer of the used instant film, typically as ISO 800, defines the digital sensor's sensitivity ISO.

In addition, the current available film cartridges are slightly larger than the square 6×6 TLR camera format. As a result, the instant film will present a darker thin line (unexposed zone) due to incompatible film and available image projection area at the back of the camera.

Apart from the original function of using film, there are two additional distinctive ways to reuse a vintage TLR camera presented in the current patent: either to convert it into instant film camera by using the current technology of instant film 5 or to convert it into a digital camera by inserting a camera sensor 7 and the accompanied hardware 20.

Once the initial set-up is performed on the camera by selecting the shutter speed and the aperture, an image can be taken. A cable will make the link between the camera flash signal and the power bank 2 at the input socket 14. For the instant film cartridge 5 this signal link will be used to trigger the release of the push film pin 11 that will lift the instant film, and the rollers 12 which initialize the chemical reaction and push out the instant film sheet, through the slot 15. A mechanical connection can be utilized to link the counting system of the cartridge holder 4 for instant film sheets to the TLR Camera counting system by using the TLRs camera film rolling pin 22. This will allows you to keep track of the available film sheets inside the instant film cartridge 5. For the digital cartridge the similar camera set-up is done also on an app that is in sync with the sensor, to keep both the camera 1 and sensor 7 in sync. Once the shutter is released the signal for the sensor is release via flash signal, sent to the power adaptor signal input socket 14 by a cable or wireless signal, then to the data input pins 16, then to the cartridge data receiving socket 17, that will activate the camera sensor 7. The optical signal (light) is captured by the sensor 7 and processed by the data processing unit 20 (placed inside of the digital cartridge), filtered and refined, and ultimately gets stored on a micro-SD 19 as an image data file, or can be wirelessly shared/saved on a network. In order for the entire assembly to work the following is required: a power source 2, hardware electronics including the sensor 7 and data processing unit 20, a synchronizing system 21, an app and a wireless connection to a network. The delay between the camera flash input used to trigger the image capturing and the image sensor is minimal. Considering the average maximum shutter speed for a film TLR camera as 1/500 sec any delay can be controlled through the camera sensor settings in the app.

The power bank enclosure device 2 is an assembly that connects to power via USB 18, which is sent to its main battery 13. Additional electronics for power regulation can be included into the power supply 2 assemblies, including the capability for data storage on a micro-SD card 19.

The sensor module cartridge is comprised of: the image sensor 7, the sensor baseboard 20 and multiple modular devices 21 (RAM, GPS, WiFi, power regulators), that connects to the sensor's baseboard. The modular devices cartridges 5 and 6 are independent from the general assembly and can be added by the user in time once upgrades and updates are performed. That will include, but is not limited to, an increase in RAM for processing the data, GPS capabilities for location data acquisition, WiFi to local or private networks, wireless synchronization of shutter release by link to flash release input signal or other potential enhancements of the system. Additional independent microcomputers can be added to the system inside of the power bank 2 that will work in sync with the data imagine processing unit 20.

All those electronics gets a wireless link to an app that controls the camera sensor 7 functions and capabilities, as a camera control module 17. Camera module is controlled by the app that performs the basic image settings: image resolution, image format, white balance, exposure time (shutter speed), aperture, or filter (FX) settings. Those are the settings that are defined for the sensor prior to the capturing of the image, and synchronized with the physical settings on the TLR camera prior to the exposure. Once the image is captured, the image data file can be shared wirelessly on a network or could be saved on the micro-SD card 19.

1. (canceled)

2. (canceled)

3. (canceled)

1. Use of a digital cartridge inside a multipurpose cartridge back holder that is not a digital back. The process used to capture the image is by initiating the release shutter signal via flash signal that will trigger the signal capture by the camera sensor of the digital cartridge. The cartridges are swappable between instant film cartridge and digital twin lens reflex system as digital cartridge, comprising hardware, digital sensor and power solutions, all this without presenting physical modification to the original design of the film camera body itself.

5. (canceled)

2. The use of a flash sync signal of a film camera for providing data input for triggering the capture release signal for instant film cartridge or system assembly or devices for capturing a digital image placed inside of a film camera body.

7. (canceled)
